(19) United States
(12) Patent Application Publication
(10) Pub. No.: US 2026/0288983 A1
(43) Pub. Date: Sep. 24, 2026

(54) SECURITY OBJECT VISIBILITY AND PRIVILEGE ADJUSTMENT

(71) Applicant: ENTRUST CORPORATION, Shakopee, MN (US)

(72) Inventors: Aleix DALMAU, Terrassa (ES); Albert FERRATE, Barcelona (ES); Tushar TAMBAY, Sunnyvale, CA (US); Michael LOGER, Garching bei Muenchen (DE); Mang Kang YONG, Concord, CA (US)

(21) Appl. No.: 19/572,526

(22) Filed: Mar. 19, 2026

Related U.S. Application Data
(60) Provisional application No. 63/775,020, filed on Mar. 20, 2025.

(51) Int. Cl. G06F 21/60

(52) U.S. Cl. CPC G06F 21/604; G06F 2221/2141

(57) ABSTRACT

A security object compliance manager layer can be provided connected to multiple vaults each containing security objects. The security object compliance manager layer obtains security actions across the vaults, and the security actions or a summary of the security actions can be presented to a user. The security object compliance manager can receive summary logs generated by each of the vaults from which the security actions can be obtained. The security object compliance manager can use the obtained security actions to determine policy changes to roles or privileges of users to correspond with the access required by the users.

### CROSS-REFERENCE TO RELATED APPLICATIONS

This application claims the benefit of U.S. Provisional Application No. 63/775,020, titled “SECURITY OBJECT VISIBILITY AND PRIVILEGE ADJUSTMENT,” filed Mar. 20, 2025, the contents of which are herein incorporated by reference in their entirety.

### BACKGROUND

Large enterprises store a wide variety of types of secure data. Such secure data is typically maintained in a secure state through use of security objects, for example, encryption keys, secrets, and certificates. Such security objects may be maintained in various secure storage locations, for example in an on-premises appliance, such as a Hardware Security Module (HSM), or within various virtual appliances like key vaults, secret vaults, or certificate storage locations either within the enterprise or within private or public cloud storage. The security objects, such as keys and secrets, may be maintained within distributed physical or virtual “vaults” throughout an enterprise. Such vaults may be distributed across an organization and represent the single control point for each respective set of security objects maintained by the respective vaults. The security objects can be managed by key management services (KMS) dedicated to managing particular sets of keys for particular resources. The dedicated nature of such KMSs does not allow for a holistic view of security actions across networked systems, or particular user’s scope of security actions.

### SUMMARY

The present disclosure is directed to a security object compliance manager providing visibility regarding user roles and security actions across various resources and vaults of security objects and controlling user group assignments, roles, or privileges to reduce security risk.

A security object compliance manager as a compliance level resides “above” (e.g., having a view of and access to administrative information of) vaults containing security objects is uniquely positioned to track security actions across different resources. This can provide improved visibility of security in networked systems, thus allowing the security to be controlled to reduce risks. Additionally, the tracking can accurately follow the security actions of users, allowing the group(s) the user belongs to, roles and/or privileges of the users to be controlled to limit the scope of privileges to enhance security without revoking privileges that may be important to users, thereby improving security in enterprise systems.

In an embodiment, a security object compliance management system includes one or more processors and one or more memories. The one or more memories store instructions that, when executed, cause the one or more processors to communicatively connect to a plurality of vaults in use by an enterprise Each vault of the plurality of vaults is configured to contain security objects associated with the enterprise. The instructions further cause the processor to obtain usage data for the security objects of each of the plurality of vaults and display a report based on the usage data.

In an embodiment, a computer-implemented method for tracking usage of security objects includes communicatively connecting to a plurality of vaults in use by an enterprise, each vault of the plurality of vaults configured to contain security objects associated with the enterprise, obtaining usage data for the security objects of each of the plurality of vaults, and displaying a report based on the usage data.

In an embodiment, a system for recommending access privilege levels for one or more users includes one or more processors; and one or more memories. The one or more memories store instructions that, when executed, cause the one or more processors to communicatively connect to a plurality of vaults in use by an enterprise, each vault of the plurality of vaults configured to contain security objects. Each vault of the plurality of vaults is configured to contain security objects associated with the enterprise. The instructions further cause the one or more processors to obtain usage data for the security objects of each of the plurality of vaults, receive access privileges for a user, compare the usage data to the access privileges for each of the plurality of users to determine removable access privileges of the user, determine proposed access privileges for the user. The proposed access privileges remove one or more of the removable access privileges. The instructions further cause the one or more processors to direct display of the proposed access privileges.

### BRIEF DESCRIPTION OF THE DRAWINGS

FIG. 1 shows an example enterprise environment including a key control management system.

FIG. 2 shows an example key control management system.

FIG. 3 shows an example method for determining security actions across a key control management system.

FIG. 4 shows an example method for determining improved security policies.

FIG. 5 shows an example computing device.

FIG. 6 shows an example graph database for storing usage of security objects.

FIG. 7 shows an example user interface displaying security object usage data tracked in a key control management system.

FIG. 8 shows an example user interface displaying a security object including usage data for the security object.

FIG. 9 shows an example user interface showing a forensic report generated by a key control management system in response to a user query.

FIG. 10 shows an example user interface displaying security policy adjustments determined by a key control management system.

FIG. 11 shows an example user interface displaying security object data including security object usage data.

### DETAILED DESCRIPTION

The present disclosure is directed to a security object compliance manager providing visibility regarding user roles and security actions across various resources and vaults of security objects and controlling user group assignments, roles, or privileges to reduce security risk.

A security object compliance manager as a compliance layer for a plurality of vaults is particularly positioned to capture usage data for all security objects across the various vaults. This can include security objects across different resources, allowing comprehensive awareness of security object usage across an organization. The awareness of security object usage can be queried by one or more of the date or time of usage, the individual user associated with use of the security object, and/or by particular security object(s). Such awareness can improve awareness of potential security risks and the adequacy and security of current structures, thereby allowing administrators to monitor and improve the security of computer systems across an enterprise. The awareness of security object usage by user can also allow user privileges to be audited effectively. In some embodiments, the security object compliance manager can suggest the reductions to be made to the scope of user access privileges. User groups, roles, privileges, and the like can thus be tailored to the user’s needs with reduced over-privileging, thus reducing security risks. Embodiments of the present disclosure thus improve the security of computer networks.

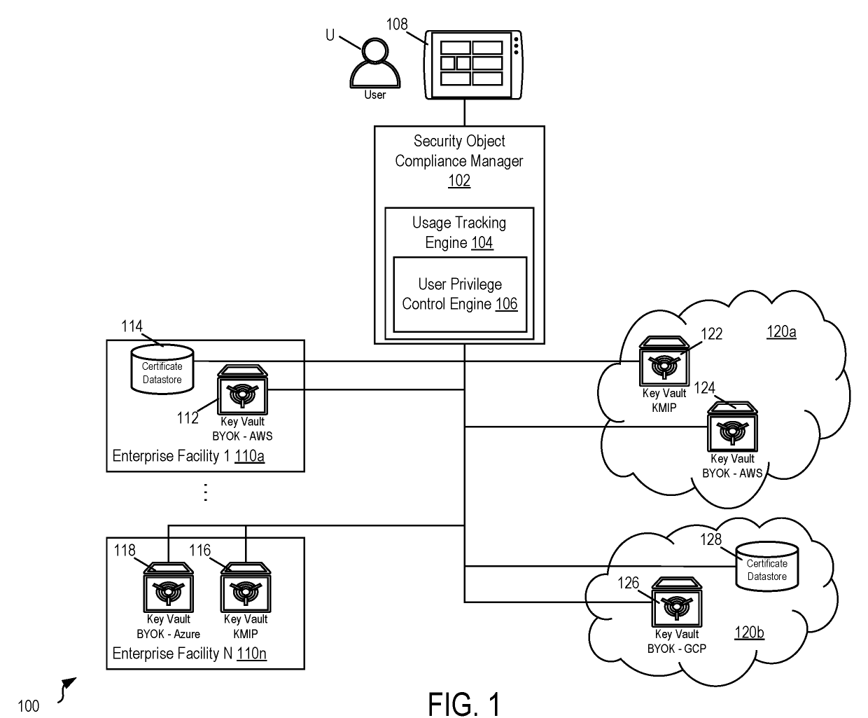

FIG. 1 shows an example enterprise environment. Enterprise environment 100 can include a security object compliance manager 102. Security object compliance manager 102 may generate and present a user interface to a user U, for example on a user device 108. In embodiments, the user interface presented to the user U includes a user interface presenting reports on usage data for security objects of the enterprise environment 100. The user device 108 may be located locally to, or remote from, the security object compliance manager 102.

Security object compliance manager 102 is a compliance layer observing the security object usage of computing resources across the enterprise environment 100. Security object compliance manager 102 may be configured to discover, and connect to, a plurality of enterprise security object storage locations. The security object storage locations can be, for example, different vaults configured to store secrets, certificates, access keys, and the like. The security object compliance manager 102 can include a usage tracking engine 104 configured to track usage information for various security objects across the enterprise environment 100, and to provide reports on security object usage by resource, user, and/or time. In an embodiment, the security object compliance manager 102 can include a user privilege control engine 106 configured to recommend changes to user access privileges, roles, or the like based on the usage of security objects by users.

The enterprise environment 100 can include one or more enterprise facilities 110a-n, at which various computing resources may be located. Such computing resources may include, for example, key vaults, certificates storage databases, secret vaults, and the like. Various types of key, certificate, or secret vaults may be maintained at each facility. Examples of vaults can include a Key Management Interoperability Protocol (KMIP) vault, a secrets vault, a cloud control vault, a certificate vault, a Transparent Data Encryption (TDE) key vault, a “Bring Your Own Key” (BYOK) vault, or the like. In the example shown, a first enterprise facility 110a includes a first key vault 112, as well as a certificate database 114. A second enterprise facility 110n includes two additional key vaults 116, 118. Key vaults 116, 118 are shown to be different types of key vaults, e.g., specific to various cloud security keys, local keys, and the like. Security objects in the vaults can be interrelated, for example having a KMIP key encrypt a cloud control key, or the like.

In addition to the enterprise facilities 110a-n, one or more cloud storage locations 120a-b may be included within control of an enterprise and may host various types of security object storage locations. In the example shown, a first cloud storage location 120a includes two different key vaults 122, 124, each representing a different type of key vault (e.g., a KMIP vault and BYOK vault). A second cloud storage location 120b can include a further key vault 126, as well as a certificate data store 128. In the example shown, although the first and second cloud storage locations each maintain a BYOK vault (e.g., vaults 124, 126), these key vaults may store different types of keys, for example keys associated with different cloud storage providers, such as Amazon, Google, Azure, and the like. The various vaults 112, 114, 116, 118, 122, 124, and 126 of enterprise environment 100 can be separate vaults that are accessed separately to use the respective security objects contained therein.

Usage tracking engine 104 is configured to track the use of security objects across enterprise environment 100. In an embodiment, usage tracking engine 104 can log each use of a security object from one of vaults 112, 116, 118, 122, 124, or 126. The log can include a time of use of the security object, a user that is using the security object, the operation performed and/or resource accessed using the security object, and the like. In an embodiment, usage tracking engine 104 can track the usage of security objects by polling the vaults such as vaults 112, 116, 118, 122, 124, or 126 to obtain logs or summaries thereof from said vaults, and to process the logs or summaries to obtain the usage of the security objects. In an embodiment, usage tracking engine 104 can request logs or summaries thereof from a vault during the onboarding of the vault into the security object compliance manager 102. In an embodiment, the usage tracking engine can receive the logs or summaries thereof passively, for example where the vaults automatically provide the summaries based on, for example, a schedule, a trigger detected at the vault, or the like. In an embodiment, the logs or summaries thereof can be provided from the vault to the usage tracking engine 104 without input or prompting from the usage tracking engine 104. Usage tracking engine 104 can be configured to store the usage data, for example by writing the usage data to a database such as a graph database, a relational database, or the like stored in one or more memories. User tracking engine 104 can obtain and store usage data across all underlying services and resources of the enterprise environment 100. In an embodiment, data from user tracking engine 104 can be used to combine usage data across various resources of the enterprise environment 100.

User privilege control engine 106 is configured to compare security object usage data for one or more users to the access privileges of one or more users and determine recommended changes to the access privileges of the users. The user privilege control engine 106 can receive the security object usage data from usage tracking engine 104. The user privilege control engine 106 can determine the recommended changes to access privileges of the user, for example, based on the usage of security objects by the one or more users in the usage data from usage tracking engine 104 compared with the scope of access provided to the one or more users according to their respective roles, rules, privileges, and the like.

The comparison of usage of security objects with scope of access can lead to the identification of access privileges that are not used by the one or more users, identifying areas of “over-privilege” where user privileges can be reduced with relatively lower impact on the ability of the user to access needed resources. Access privileges that are provided in, for example, the role of a user, access policies for the user, or the like that are not actually exercised by the one or more users can be identified as candidates for removal, for example by adjusting a user’s role, modification of the privileges associated with a role, modification of trust manifests such as addition of constraints, or the like. In an embodiment, the access level update can reduce user access privileges from the previous set of user access privileges, while remaining broader than the set of access privileges actually exercised by the one or more users.

In an embodiment, the access privileges retained by a user can be based on predicted user access needs, for example based on the security object usage of other users in similar roles, security objects associated with the security objects accessed by the user, access needs relating to operations performed by the user or resources accessed by the user, or the like. For example, where a user is an administrator of cloud control, but only performs read operations in cloud control and does not perform other actions, the user can be considered over-privileged with respect to cloud control. The over-privilege could be reduced by reducing the user’s status from administrator to a lower level role retaining the ability to perform the read operations. The number and type of operations performed by the user can be used to determine whether the user is over-privileged, for example if the user possesses far more operational privileges than are actually used. In an embodiment, over-privilege can be determined based on analysis of unused operations available to the user or operations performed in an amount below a predetermined threshold. In an embodiment, privilege adjustment can be performed by comparing the operations performed by a user to a plurality of role definitions to determine a role providing the required operations with the least over-privilege. In an embodiment, the privileges associated with particular roles can be changed, for example where user roles include privileges for operations that no users having that role actually perform.

User device 108 can be located locally to, or remote from, the security object compliance manager 102. User device 108 can provide a user interface, for example displaying security object usage data and/or recommended changes to access privileges of users. The user device 108 can receive inputs through the user interface, such as queries to be performed on a database containing the security object usage data, requests for particular presentation of the security object usage data in the user interface, or the like.

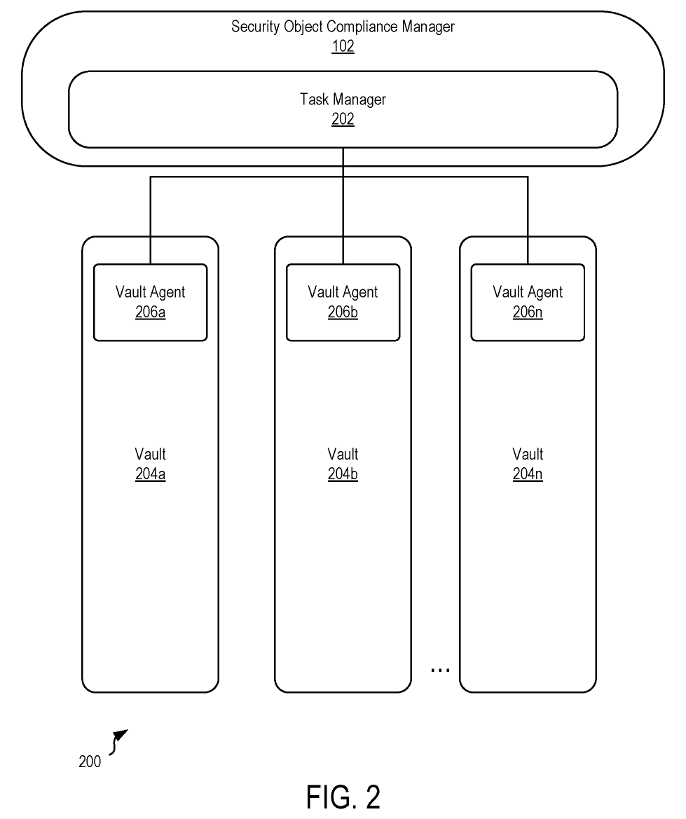

FIG. 2 shows an example key control management system. Key control management system 200 includes security object compliance manager 102 including a task manager 202, and vaults 204a-n. Each of vaults 204a-n can include a respective vault agent 206a-n.

Key control management system 200 is an example embodiment of an architecture for obtaining security object usage data from a plurality of vaults 204a-n. Security object compliance manager 102 is a compliance layer over the vaults 204a-n of the enterprise. In the embodiment shown in FIG. 2, security object compliance manager 102 includes task manager 202. The task manager 202 can coordinate and request tasks be performed by services and microservices within key control management system 200. In an embodiment, task manager 202 can direct security object usage data to be provided, for example to usage tracking engine 104, such that the usage tracking engine 104 can obtain and record security object usage data for the enterprise. In an embodiment, vault agents 206a-n can autonomously provide the security object usage data to the usage tracking engine 104, for example through periodic reporting. For example, task manager 202 can schedule or request the preparation or provision of data for the determination of security object usage data. For example, the task manager 202 can request or schedule the preparation of log summary files by the respective vault agents 206a-n of the vaults 204a-n.

Vaults 204a-n are each a repository of security objects under security object compliance manager 102. The vaults 204a-n can each store one or more different types of security objects such as keys, secrets, certificates, or the like. In an embodiment, vaults 204a-n each contain different types of security objects. In an embodiment, the security objects contained in vaults 204a-n are associated with particular different resources. In an embodiment the security objects contained in vaults 204a-n are for a plurality of resources, for example different cloud storage providers, services, and the like. The vaults 204a-n can include any vault associated with the enterprise, including vaults stored in enterprise storage such as enterprise facilities 110a-n and vaults contained in cloud storage such as cloud storage 120a,b as shown in FIG. 1 and discussed above. The vaults 204a-n can include a Key Management Interoperability Protocol (KMIP) vault, a secrets vault, a cloud control vaults, a certificate vault, a Transparent Data Encryption (TDE) key vault, a “Bring Your Own Key” (BYOK) vault, or the like.

Vault agents 206a-n can be services or microservices implemented within the respective vaults 204a-n. The vault agents 206a-n can be configured to perform tasks such as obtaining log files, generating log summaries, providing log files or log summaries to the security object compliance manager 102, and the like. The vault agents 206a-n can be configured to run tasks periodically and/or when triggered by a message from task manager 202. In an embodiment, the vault agents 206a-n are each configured to prepare a log summary for their respective one of vaults 204a-n. The log summary can be prepared by obtaining a detailed log for the vault. The detailed log can include, for example, users or subjects, resources accessed, operations performed, time and date of the operations, source IP address for requests, acceptance or denial of the access request, and the like for each operation performed involving security objects of the vault. The vault agents 206a-n can read the detailed log, parse the contents to discard data not relevant to the usage of security objects, and create an aggregation of the data relevant to the usage of security objects to form the summary log. The aggregation can be performed according to, as a non-limiting example, the “group by” statement in SQL. The aggregation can be provided from the vault agent 206a-n to the usage tracking engine 104, for example by way of task manager 202, such that usage tracking engine 104 obtains security object usage data for each of the vaults 204a-n. Generating respective summary logs at each vault 204a-n and then combining the summary logs to obtain the security object usage information can improve the efficiency when generating the security object usage information, and can render the security object usage information in a format conducive to storage and search and retrieval tasks.

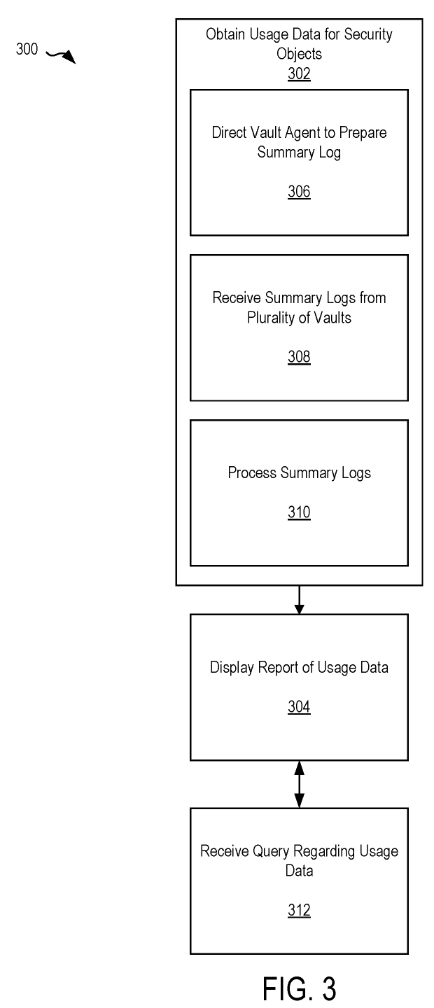

FIG. 3 shows an example method for determining security actions across a key control management system. Method 300 includes obtaining usage data for security objects of a plurality of vaults 302 and displaying a report based on the usage data 304. In an embodiment, the obtaining of usage data at step 302 can include directing a vault agent to prepare a summary log of the vault at step 306, receiving summary logs from each of a plurality of vaults 308, and processing the summary logs 310. Optionally, method 300 can include receiving a query regarding the usage data 312.

Usage data is obtained for security objects of a plurality of vaults at step 302. The plurality of vaults can include various security object vaults across an enterprise, such as the vaults 112, 116, 118, 122, 124, and 126 or the vaults 204a-n discussed above. In an embodiment, the usage data can be obtained at step 302 by user tracking engine 104, for example through logging of uses of security objects, obtaining logs or summaries thereof from the vaults, or the like. The usage data can include data regarding the security object being used, the user making use of the security object, the time of use of the security object, the operation being performed on or using the security object, the resource the security object is being used with, and the like. The usage data can be stored in a database, for example to allow for the retrieval of usage data in response to queries. Examples of suitable databases include a graph database, a relational database, or the like.

In an embodiment, the obtaining of usage data at step 302 can include directing a vault agent to prepare a summary log of the vault at step 306, receiving summary logs from each of a plurality of vaults 308, and processing the summary logs 310.

The vault agent can prepare a summary log for the vault at step 306. The vault agent can be, for example, the particular vault agent 206a-n of the respective vault 204a-n. The vault agent can execute a task reading the logs for the respective vault, parse the contents to discard data not relevant to the usage of security objects, and create an aggregation of the data relevant to the usage of security objects to form the summary log. The aggregation can be performed according to, as a non-limiting example, the “group by” statement in SQL. Step 306 can be performed periodically and/or when requested by a task manager of a security object compliance manager, such as task manager 202 described above.

The security object compliance manager can receive the respective summary logs from each of a plurality of vaults at step 308. The summary logs can be received from some or all of the vaults managed by the security object compliance manager, such as any or all of vaults 112, 116, 118, 122, 124, and 126 or the vaults 204a-n discussed above. The summary logs received at step 308 can be processed at step 310. Processing of the summary logs at step 310 can include parsing or formatting the summary logs to render the contents of the summary logs suitable for storage in a database containing the security object usage data such as a graph or relational database. As an example, the processing of the summary logs at step 310 can identify the users, groups, security objects being used, the vaults containing the security objects, the resource the security vault is used with, trust manifests, rules, roles, and operations provided in the summary logs and associated with particular uses of the security objects, and to create entries including some or all of this data for each use of the security objects provided in the summary logs.

Optionally, a query regarding the usage data can be received at step 312. The query can identify one or more parameters to be used to obtain particular usage data for display at step 304. The query can include one or more of a date range, a particular vault, a particular resource, a particular user, or combinations thereof. Based on the content of the query, usage data responsive to the query can be retrieved from a database containing the usage data obtained at step 302. The query received at 312 can be carried out in the database by any suitable software managing the database or allowing for the searching thereof. The responsive usage data can be used to generate the report displayed at step 304. In an embodiment, the query can be stored and displayed in a dashboard. The dashboard can be a custom dashboard created using a development tool including an interactive interface for receiving input on dashboard features, for example a chatbot configured to guide input of parameters for the dashboard and/or queries stored and displayed therein.

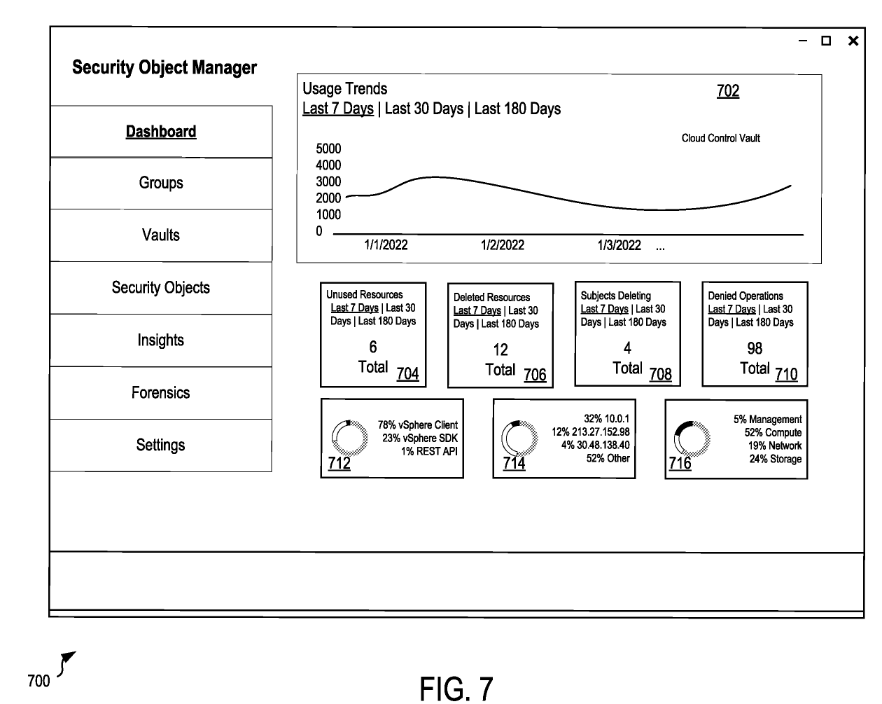

A report is displayed at step 304 based on the usage data for the security objects. The report can be generated based on the usage data obtained at step 302. The report can be generated by retrieving suitable data, such as general usage data, or specifically requested data such as data retrieved in response to receipt of a query at step 312. The report can be displayed to a user through a display of a user device, such as user device 108 of the user U as shown in FIGS. 1 and 2. In an embodiment, the graphical data can include a time series showing use of security objects over time or the like. The report can be displayed at step 304 as part of a dashboard including one or more inputs for a query or elements thereof. The report can include textual and numerical data, graphical data, and the like. For example, the dashboard including the report can provide one or more interfaces allowing selection of a date range, a particular vault, a particular resource, a particular user, or combinations thereof to request or filter usage data for presentation to the user. In an embodiment, the query optionally received at step 312 can be input through such a dashboard accompanying a report presented at step 304, for example to refine results, focus on particular users or time periods, or the like. In embodiments, the reports can be presented at 304 by display in a user interface such as the user interfaces 700, 800, or 900 described below and respectively shown in FIGS. 7-9. Additional reports and user interfaces may be presented to a user, for example as described in U.S. Provisional Application No. 63/775,027 entitled “VISIBILITY AND MANAGEMENT OF IMPACTS OF SECURITY OBJECT COMPROMISE IN SECURITY OBJECT COMPLIANCE MANAGER”, filed Mar. 20, 2025, and U.S. Provisional Application No. 63/868,610, also titled “VISIBILITY AND MANAGEMENT OF IMPACTS OF SECURITY OBJECT COMPROMISE IN SECURITY OBJECT COMPLIANCE MANAGER,” filed Aug. 22, 2025, the disclosures of which are hereby incorporated by reference in their entirety.

In one example, the report presented at step 304 can provide insights based on the aggregation of data from the multiple vaults. For example, where a user has an administrative role for each of multiple vaults, and performs actions in a first vault within one time frame and performs actions in a second vault at another time, the respective time frames can be used to define windows for the user interacting with each vault. Such time windows can provide insight into user behaviors and working hours. The time windows and user behavior insights can be used to control user actions so as to improve security outside of the time frames by controlling access while allowing the user to maintain their work patterns and timing.

A further example of an insight based on the aggregation of data from the multiple vaults that can be included in a report presented at step 304 is a total amount of operations that were denied across the vaults of the entire enterprise.

In another example, the report presented at step 304 can provide insights based on a comparison of data from the multiple vaults. For example, the average users per day of a first vault can be compared with the average users per day of a second vault. Consistent metrics for each vault can be compared directly, creating a clearer understanding of relative usage, risk, importance, and the like for the multiple vaults.

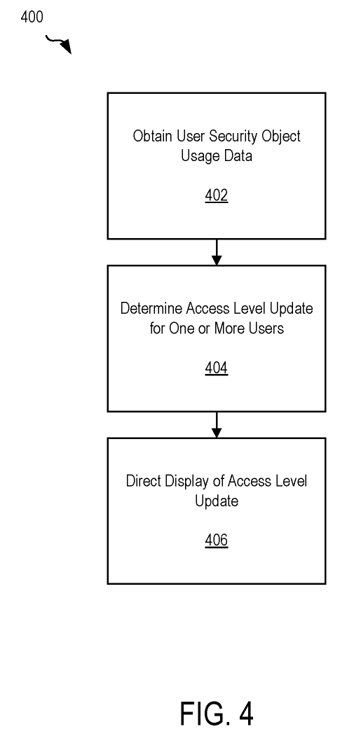

FIG. 4 shows an example method for determining improved security policies. Method 400 includes obtaining security object usage data for one or more users, determining an access level update for the one or more users, and directing display of the access level update.

Security object usage data for one or more users is obtained (step 402). The usage data is data regarding usage of security objects by a given one or more users. In an embodiment, the usage data can be for an individual user for whom access privileges are to be audited or adjusted. In an embodiment, the usage data can be for a plurality of users, such as users all having a particular role or access level, users within a group or division, or the like. The usage data can be obtained, for example, from usage tracking engine 104 of the security object compliance manager 102. The usage data can be obtained, for example, by directing a vault agent to prepare a summary log of the vault 306, receiving summary logs from each of a plurality of vaults 308, and processing the summary logs 310 as described above and shown in FIG. 3. The usage data can include the security objects a particular user interacts with. The usage data can include frequencies or total numbers of interactions of the one or more users with particular security objects, operations being performed when accessing security objects, and the like. The usage data can be usage data for a given period of time, for example a last year, last six months, last 30 days, or another predetermined period.

An access level update for is determined for one or more users (step 404). The access level update can be determined based on the usage of security objects by the one or more users compared with the scope of access provided to the one or more users. The usage of security objects by a user can be usage over all time, usage over a selected period of time, the use of security objects can be weighted based on when the usage occurred, or the like. The access level update can be based on access privileges that a user possesses, for example as part of their current role, and the actual usage of access privileges by the user. In an embodiment, the access level update can be determined based on a comparison of operations performed by the user with the access privileges possessed by the user. In an embodiment, access privileges that are unused or are used below a predetermined threshold can be determined to be removable access privileges, and potentially removed in the access level update determined at step 404. Removable access privileges can be privileges that are unused, only used below a threshold value for usage, only used intermittently with time gaps between uses exceeding a threshold value, or other behavioral patterns indicative of the access privilege not being critical to the user. In an embodiment, the access level update can include comparing the operations performed by the user with access permissions provided to particular roles such as administrator, power user, categories thereof, etc. The access level update can be a change to a user role based on the role having the least privileges that includes all operations performed by the user. In an embodiment, the access level update can be determined using a grouping technique, such as K-means clustering, to determine a group of privileges suitable for a user based on their history of security object usage. The comparison of usage of security objects with scope of access can lead to the identification of access privileges that are not used by the one or more users, identifying areas of “over-privilege” where user privileges can be reduced with relatively lower impact on the ability of the user to access needed resources. The over-privilege can be determined based on usage, frequency of usage compared to a threshold, timing of usage, and other such indicators of a user’s access requirements. Access privileges that are provided in, for example, the role of a user, access policies for the user, or the like that are not actually exercised by the one or more users can be identified as candidates for removal, for example by adjusting a user’s assignment to a group, the user’s role, the role to which the user’s group is assigned, modification to the permissions and privileges associated with a role, or the like. The access level update can be determined such that at least some of the candidates for removal are removed from the set of access privileges available to the one or more users.

As described above, security object usage information from the multiple vaults can be used to determine working hours and behaviors of a user. The working hours and behavioral information can be used to, for example, propose limiting times a user can act on certain security objects. This can enhance security by preventing after-hours actions that are less likely to be by the actual user.

In another example, a user can have privileges for performing actions in multiple vaults. In this example, the security object usage data associated with that user can indicate that certain security objects in one vault are not used by the user, but similar security objects in another vault are used by the user. The access privileges of the user can be tailored to the respective security objects they use from each of the multiple vaults where the user takes certain actions. Access privileges can thereby be tailored across the different vaults, avoiding being overly restrictive by removing all access to a type of security object while still reducing the user’s privileges to improve security.

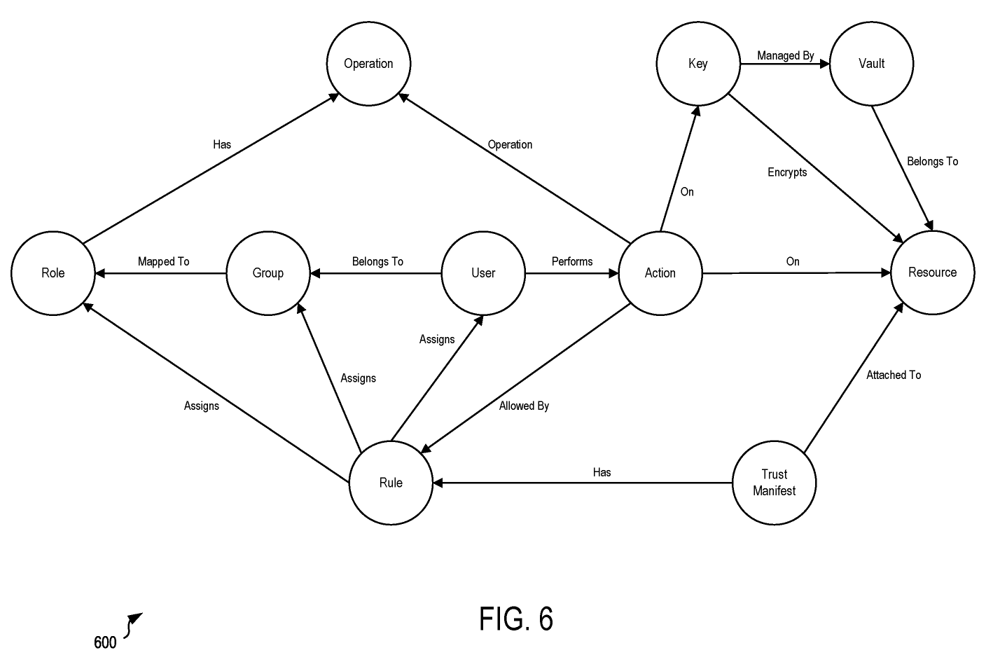

In an embodiment, the access level update can reduce user access privileges from the previous set of user access privileges, while remaining broader than the set of access privileges actually exercised by the one or more users. In an embodiment, the access privileges retained by a user can be based on predicted user access needs, for example based on the security object usage of other users in a same or similar group, similar roles, access needs relating to operations performed by the user or resources accessed by the user, risks associated with particular types of access or security objects, or the like. The access level update determined at step 404 can include changes to user privileges for an individual user, such as a change in group the individual user is assigned to, a change individual access privileges, changes to privileges for classes of users or for particular security operations, such as modifying the access privileges associated with certain roles, adding constraints to trust manifests, or the like. In an embodiment, the determination of the access level update can be performed by applying a pathfinding or shortest path algorithm to a database containing the security object usage data, for example the graph database 600 described below and shown in FIG. 6. In an embodiment, the user privilege control engine 106 of FIG. 1 can be used to determine the access level update.

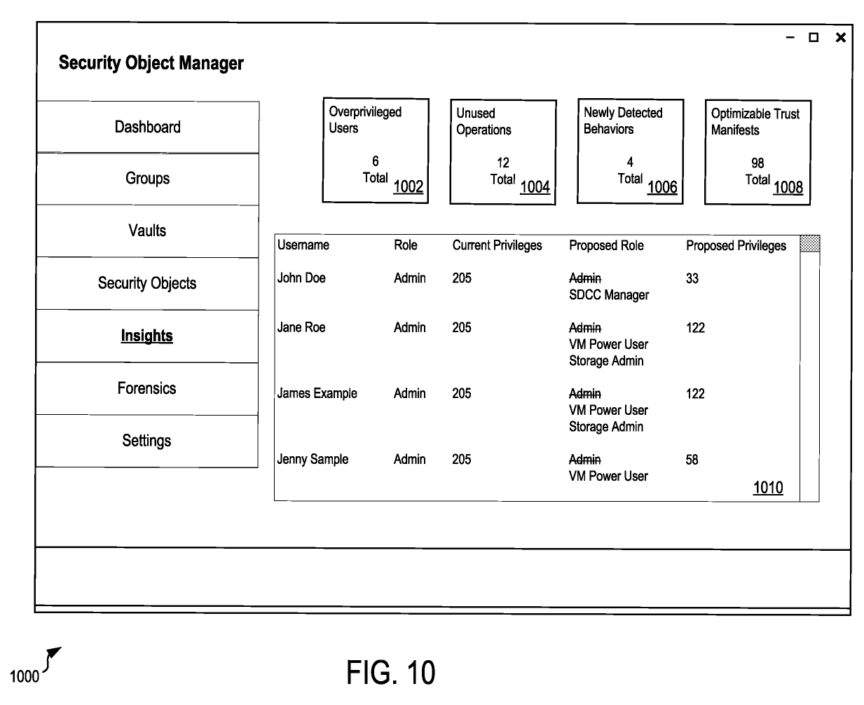

The access level update is displayed (step 406). The access level update can be provided to a device, such as user device 108, for display to the user U. The access level update can be displayed, for example, as a list of users having access level updates, the user’s current roles and/or privileges, and the suggested roles and/or privileges of the access level update determined for the user. In an embodiment, the access level update can be displayed in a user interface such as the user interface 1000 described below and shown in FIG. 10. In an embodiment, the user viewing the access level update can be provided a link or other interactable object to enter or approve the change(s) to roles and/or privileges provided the access level update displayed in 406. In an embodiment, the user can manually enter the change(s) to roles and/or privileges provided the access level update displayed in suitable interfaces.

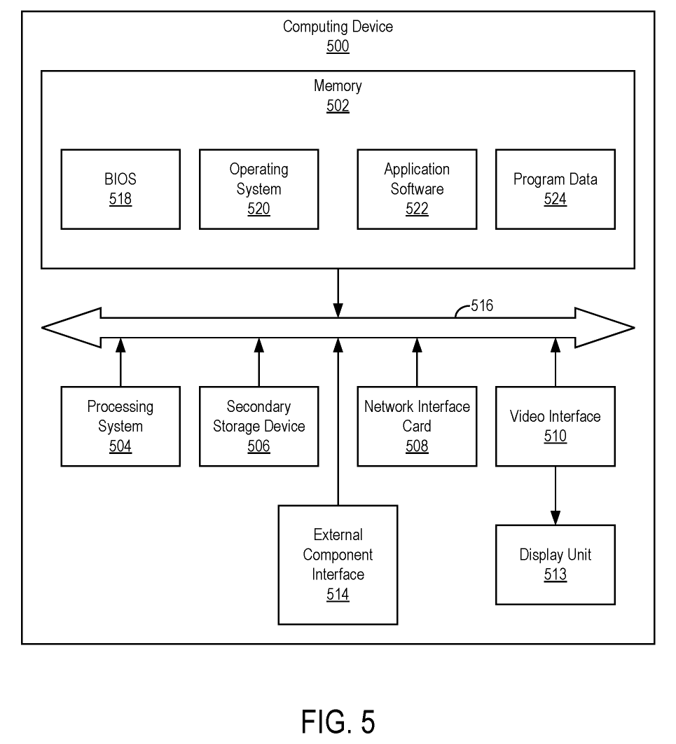

FIG. 5 illustrates an example computing device 500 on which aspects of the present disclosure may be implemented. The computing device 500 can be used, for example, to implement computing devices such as the centralized compliance platform 102, the user device 108, or various enterprise hardware used to implement the security object storage locations described herein.

In the example of FIG. 5, the computing device 500 includes a memory 502, a processing system 504, a secondary storage device 506, a network interface card 508, a video interface 510, a display unit 513, an external component interface 514, and a communication medium 516. The memory 502 includes one or more computer storage media capable of storing data and/or instructions. In different embodiments, the memory 502 is implemented in different ways. For example, the memory 502 can be implemented using various types of computer storage media, and generally includes at least some tangible media. In some embodiments, the memory 502 is implemented using entirely non-transitory media.

The processing system 504 includes one or more processing units, or programmable circuits. A processing unit is a physical device or article of manufacture comprising one or more integrated circuits that selectively execute software instructions. In various embodiments, the processing system 504 is implemented in various ways. For example, the processing system 504 can be implemented as one or more physical or logical processing cores. In another example, the processing system 504 can include one or more separate microprocessors. In yet another example embodiment, the processing system 504 can include an application-specific integrated circuit (ASIC) that provides specific functionality. In yet another example, the processing system 504 provides specific functionality by using an ASIC and by executing computer-executable instructions.

The secondary storage device 506 includes one or more computer storage media. The secondary storage device 506 stores data and software instructions not directly accessible by the processing system 504. In other words, the processing system 504 performs an I/O operation to retrieve data and/or software instructions from the secondary storage device 506. In various embodiments, the secondary storage device 506 includes various types of computer storage media. For example, the secondary storage device 506 can include one or more magnetic disks, magnetic tape drives, optical discs, solid-state memory devices, and/or other types of tangible computer storage media.

The network interface card 508 enables the computing device 500 to send data to and receive data from a communication network. In different embodiments, the network interface card 508 is implemented in different ways. For example, the network interface card 508 can be implemented as an Ethernet interface, a fiber optic network interface, a wireless network interface (e.g., WiFi, WiMax, Bluetooth, etc.), or another type of network interface.

In optional embodiments where the video interface 510 is included in the computing device 500, the video interface 510 enables the computing device 500 to output video information to the display unit 513. The display unit 513 can be various types of devices for displaying video information, such as an LCD display panel, a plasma screen display panel, a touch-sensitive display panel, an LED or OLED screen, a cathode-ray tube display, or a projector. The video interface 510 can communicate with the display unit 513 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 514 enables the computing device 500 to communicate with external devices. For example, the external component interface 514 can be a USB interface and/or another type of interface that enables the computing device 500 to communicate with external devices or peripheral devices integrated within the same housing (e.g., in the case of mobile devices). In various embodiments, the external component interface 514 enables the computing device 500 to communicate with various external components, such as external storage devices, input devices, speakers, modems, media player docks, other computing devices, scanners, digital cameras, and fingerprint readers.

The communication medium 516 facilitates communication among the hardware components of the computing device 500. The communications medium 516 facilitates communication among the memory 502, the processing system 504, the secondary storage device 506, the network interface card 508, the video interface 510, and the external component interface 514. The communications medium 516 can be implemented in various ways. For example, the communication medium 516 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 502 stores various types of data and/or software instructions. The memory 502 stores a Basic Input/Output System (BIOS) 518 and an operating system 520. The BIOS 518 includes a set of computer-executable instructions that, when executed by the processing system 504, cause the computing device 500 to boot up. The operating system 520 includes a set of computer-executable instructions that, when executed by the processing system 504, cause the computing device 500 to provide an operating system that coordinates the activities and sharing of resources of the computing device 500. Furthermore, the memory 502 stores application software 522. The application software 522 includes computer-executable instructions, that when executed by the processing system 504, cause the computing device 500 to provide one or more applications. The memory 502 also stores program data 524. The program data 524 is data used by programs that execute on the computing device 500.

Although particular features are discussed herein as included within an electronic computing device 500, it is recognized that in certain embodiments not all such components or features may be included within a computing device executing according to the methods and systems of the present disclosure. Furthermore, different types of hardware and/or software systems could be incorporated into such an electronic computing device.

FIG. 6 shows an example logical structure of a graph database for storing usage of security objects. The graph database 600 can be used to store security object usage information, such as the usage information obtained by security object compliance manager 102. The graph database 600 can allow the stored security object usage information to be efficiently queried by user, resource, and/or time to generate forensic reports on security object usage. Graph database 600 can be managed using any suitable database management system (DBMS), with non-limiting examples including Neo4J, Dgraph, and NebulaGraph. The example graph database 600 includes nodes for users, groups, security objects being used, the vaults containing the security objects, the resource the security vault is used with, trust manifests, rules, roles, and operations associated with particular uses of the security objects. The nodes can be connected by suitable edges, which define the nature of the relationship between two nodes. Edge types may include, for example: a “Belongs to” edge, for example shown linking a user node and a group node to capture that the user belonging to a group; a “Performs” edge, for example shown linking the user node to an action node, indicating that the user performs the action; an “Encrypts” edge, for example shown as linking a key node and a resource node and thereby identifying that the key encrypts the resource, a “Managed By” edge, for example shown as linking the key node with a vault node to indicate that the key is managed by the vault, and the like. FIG. 6 shows example edges as the lines connecting the example nodes.

The nodes and edges of the graph database 600 store the security object usage data and relationships thereof to enable efficient and intuitive queries. The query results can be computed by traversing the edges among nodes. In an embodiment, graph database 600 can be populated by processing summary logs from vaults, for example at step 310 of the method 300 described above. In embodiments, other databases can be used in place of graph database 600, such as, for example, a relational database.

FIG. 7 shows an example user interface 700 displaying security object usage data tracked in a key control management system. User interface 700 provides a dashboard including a visual representation of usage trends 702. The example dashboard of FIG. 7 further includes numerical data for each of unused resource data 704, deleted resources 706, subjects who deleted resources 708, and denied operations 710. The example dashboard of FIG. 7 additionally includes numerical and graphical representations of access method usage 712, source IP addresses 714, and operations by type 716.

User interface 700 provides a user with security object usage data for an enterprise or a portion thereof. In the example shown in FIG. 7, the user interface 700 shows information for a cloud control vault. In embodiments, the user interface 700 can present security object usage data for a plurality of vaults, such as some selected vaults or all vaults of an enterprise. Portions of the data presented on user interface 700 can be aggregated for all displayed vaults or broken out by individual vaults or selected groupings thereof. The security object usage data can be obtained, for example, according to method 300 as described above. The security object usage data can be obtained by security object compliance manager 102 as described above. The user interface 700 can presented, for example, on user device 108 to user U.

Usage trends 702 can be presented in a graphical form representing a time series of numbers of uses of the vault, for example a line graph of the number of uses of security objects contained in the vault per each day. The usage trends 702 can be displayed for a period selected by the user, such as the last seven days, the last 30 days, or the last 180 days. The usage trends 702 can be shown for one or more vaults, for example the cloud control vault in the example of FIG. 7. Additional vaults can have usage trends shown by being overlaid on one another, with suitable shading, transparency or the like to facilitate the readability of the multiple usage trends.

The tile in user interface 700 for unused resource data 704 can present a number of the security objects in the vault or enterprise that have not been accessed or used within the period selected by the user, such as the last seven days, the last 30 days, or the last 180 days. The tile in user interface 700 for deleted resources 706 can present a number of the security objects in the vault or enterprise that have been deleted from the vault or enterprise within the period selected by the user, such as the last seven days, the last 30 days, or the last 180 days. The tile in user interface 700 for subjects who deleted resources 708 can present a number of distinct users who have deleted security objects from the vault or enterprise within the period selected by the user, such as the last seven days, the last 30 days, or the last 180 days. The tile in user interface 700 for denied operations 710 can present a number of operations that were denied across the enterprise, or operations that involved the selected vault or group thereof that were denied within the period selected by the user, such as the last seven days, the last 30 days, or the last 180 days.

Access method usage 712 can show the resources used to access the security objects of the vault, group thereof, or enterprise. The access methods can include, for example, a software client, a software development kit, a software module such as an application programming interface (API) or the like. The access method usage shown in 712 can be shown in relative terms, such as a pie chart and corresponding percentages. In an embodiment, absolute numbers for instances of the resource accessing the security objects can also be provided alongside the percentages.

Source IP addresses 714 can show the IP addresses from which security objects of the vault, group thereof, or enterprise were accessed. The source IP addresses shown in 714 can include a relative breakdown of the source IP addresses or a selected subset thereof. For example, as in the example of FIG. 7, the percentages for the top three source IP addresses can be shown along with “other” for source IP addresses aside from the top three source IP addresses. The source IP addresses shown in 714 can be shown in relative terms, such as a pie chart and corresponding percentages. In an embodiment, absolute numbers for instances of the security objects being accessed from particular IPs can also be provided alongside the percentages.

Operations by type 716 show the class of operation that is associated with the access of the security objects of the vault, group thereof, or enterprise. The class of operation can be, for example, a management operation, a compute operation, a network operation or a storage operation, as shown in FIG. 7. Other classifications of operations can be used. The operations by type 716 can be shown in relative terms, such as a pie chart and corresponding percentages. In an embodiment, absolute numbers for the operations associated with access of the security objects can also be provided alongside the percentages.

In examples, users of the user interface 700 can consume holistic usage characteristics of the security objects of the enterprise across various separate vaults, even when such vaults are typically used separately. This can provide a more complete understanding of the security infrastructure across the enterprise and how it is utilized, as opposed to being siloed by or limited to particular vaults.

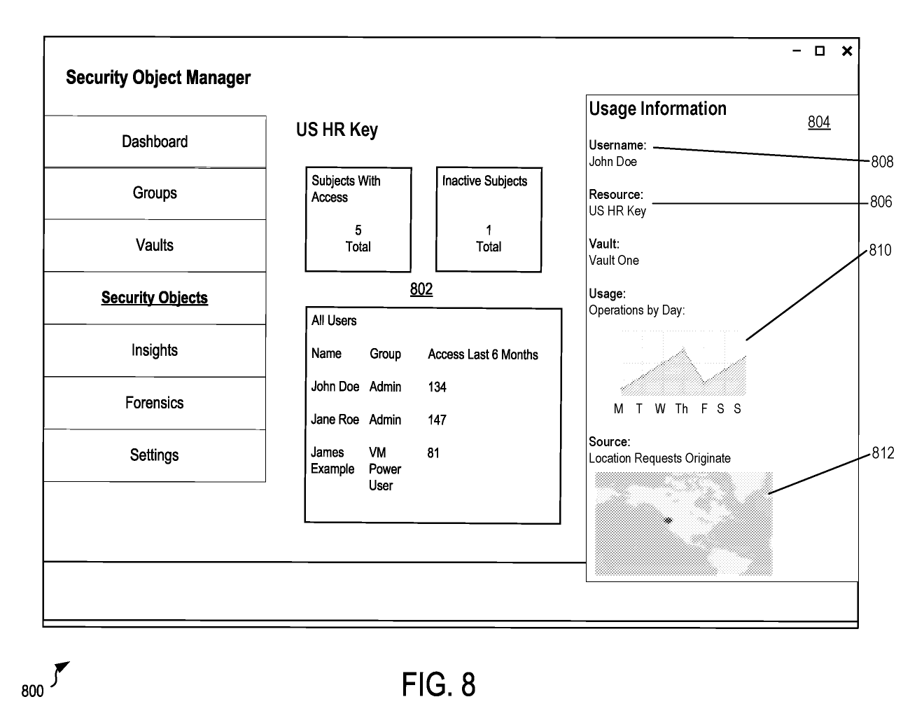

FIG. 8 shows an example user interface 800 displaying a security object including usage data for the security object. User interface 800 includes security object view 802 and usage information tab 804. Security object view 802 shows information for the security object, such as users having access, identification of users who have access but have not accessed the resource in a given period of time, a list of users with access and the numbers of times they have made use of such access, and the like. Usage information tab 804 can be presented in or over a portion of the security object view 802. Usage information tab 804 can provide further usage information, for example for a user selected from the security object view 802.

In the example of FIG. 8, usage information tab 804 includes a name of the resource 806, a username of a selected user 808, a chart showing operations performed over time using the security object 810, and a map of locations from which the operations were performed 812. Other suitable information can be presented based on user selections of options, of different fields in the security object view 802, or the like. The usage information tab 804 can allow specific usage information to be used based on selections in the security object view 802, thereby improving the availability and visibility of the security object usage information. The content of security object view 802 and usage information tab 804 can be obtained by querying a database containing the usage information, for example a database populated by the usage tracking engine 104, for example a graph database such as graph database 600, a relational database, or the like.

Overall, via user interface 800, a user may be able to view trends in usage information, and identify frequent users and rare users of specific security objects. The user interface 800 presents an overall view of not only the specific users, but geographies from which security objects are accessed and access trends, allowing administrative users to, at a glance, see and quickly identify possible adjustments to reduce access privileges according to organizational policies (e.g., accessing particular network resources from disfavored geographies, reducing access rights for users who rarely use their respective access rights, and the like).

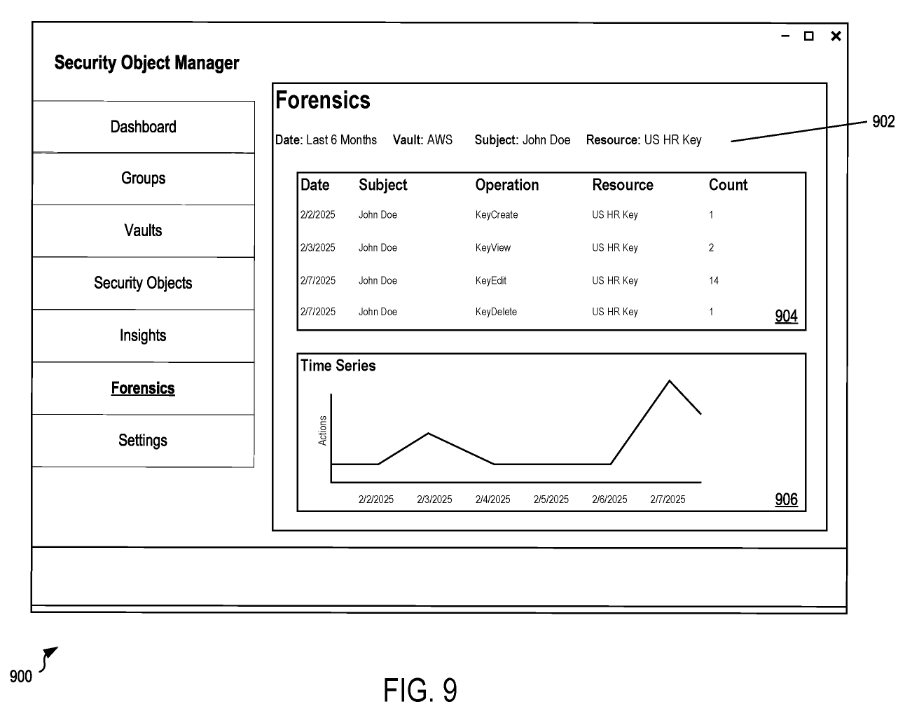

FIG. 9 shows an example user interface showing a forensic report generated by a key control management system in response to a user query. User interface 900 includes query characteristics 902, information table 904 providing requested security object usage data and time series 906 showing a graphical time series of selected usage data.

Query characteristics 902 can include the fields being queried and the query terms used in obtaining the forensic report. The fields can include identification of a date range, one or more vaults that are selected for the query, particular user that is a subject of the query, a resource that is selected for the query, and the like. In an embodiment, when a field is selected, a drop-down menu can be shown to allow selection of a parameter for the field such as a particular user, vault, resource, beginning and end dates or time period, etc. When query characteristics 902 are input or modified, the information table 904 and/or time series 906 can be recomputed or updated accordingly. The query characteristics 902 selected by the user can be used to query a database containing the usage information, for example a graph database such graph database 600, a relational database, or the like. The database can be populated with the usage information by, for example, usage tracking engine 104.

Information table 904 provides security object usage data such as dates, users, operations, resources, counts of access requests, and the like that are responsive to the query. For example, as shown in FIG. 9, various operations performed by a specific user using a selected security object can be shown. Time series 906 can provide a graphical representation of the usage data represented over a predetermined or a selected period of time. For example, information table 904 can display the counts of operations performed by the selected user when using the selected security object as shown in FIG. 9.

In examples, a user may utilize the user interface 900 to flexibly display specific usage statistics gathered across a plurality of vaults to see a consolidated view of security object usage by a particular user, or for a particular vault; the view may present, e.g., specific usage logs, frequency information and trend information, to enable monitoring of security object usage and enable appropriate management thereof.

FIG. 10 shows an example user interface 1000 displaying security policy adjustments determined by a key control management system. User interface 1000 can display a security policy tab including a display of overprivileged users 1002, unused operations 1004, newly detected behaviors 1006, and trust manifests 1008.

When the display of overprivileged users 1002 is selected, a list of users 1010 can be shown. The list of users 1010 can include the users identified as over-privileged and suggestions for reductions in the privileges of such users. The users and suggested reductions in privileges can be determined, for example, by user privilege control engine 106, as determined according to method 400, or the like. The list of users 1010 can include the user name, current role, number of current privileges, proposed role(s), and number of proposed privileges for each listed user. In some instances, the list of users may be ordered by the overall significance of the proposed change in user privileges; this may include a number of privileges to be changed or reduced, an overall importance or sensitivity of privileges to be removed, and the like.

In embodiments, the displays of unused operations 1004, newly detected behaviors 1006, and/or trust manifests 1008 can be selected by a user, and a corresponding tab can be presented in user interface 1000. Such tabs can provide additional detail related to the selected element, such as a detailed list of the unused operations, a detailed list of newly detected behaviors, or a list of trust manifests and optionally suggested modifications to such trust manifests.

In examples, a user such as an administrator can use the user interface 1000 to receive recommendations for changes to be made to access privileges and to view the underlying basis for the recommendations, allowing the user to make suitable changes to bring security privileges in line with the particular needs of users and reduce over-privilege of users within the enterprise.

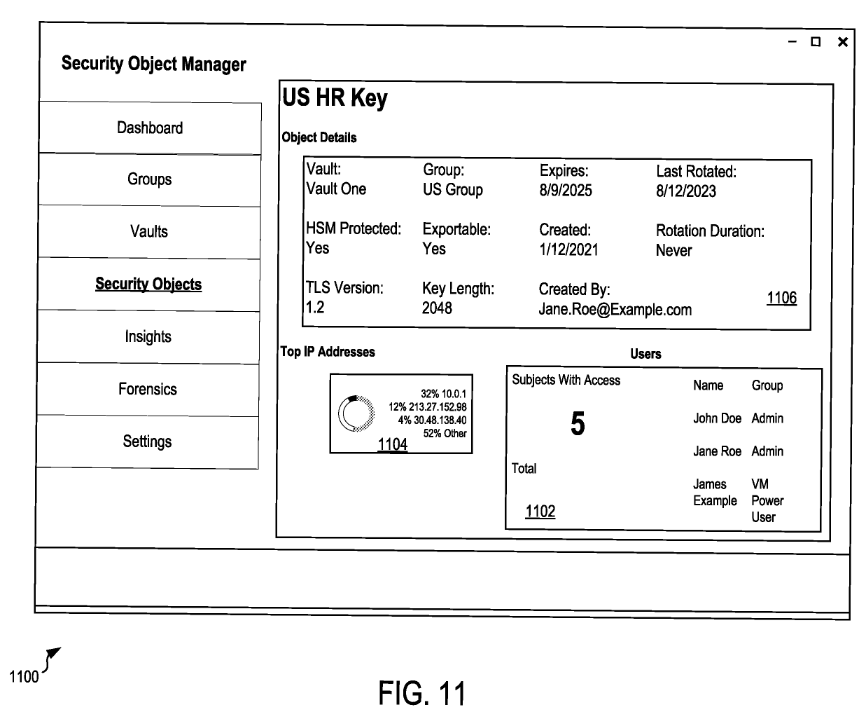

FIG. 11 shows an example user interface displaying security object data including security object usage data. In example user interface 1100, the security object usage information is integrated into a user interface showing other object details in addition to specific usage-related information. For example, in user interface 1100, the subjects with access display 1102 and the top source IP addresses 1104 can be shown alongside object details 1106. Subjects with access display 1102 can show, for example, the top 5 users in terms of accessing the security object based on the security object usage data. Top source IP addresses 1104 can show the IP addresses from which the key was most frequently accessed according to the security object usage data. Object details 1106 includes information not specific to the security object usage data, for example the HSM protection status, TLS version, key length, creation date, expiration date, rotation plans, or any other such properties of the security object. In embodiments, additional information independent of the security object usage data can be included in the object details 1106 or provided in a separate element provided in the user interface 1100.

The user interface 1100 can incorporate the usage data into other relevant data for the security object such that the data can be integrated, making the security object usage data and relevant insights therefrom more easily consumed by users of the security object compliance management system without needing to access specialty interfaces or needing to interact with specific elements thereof.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

What is claimed is:

1. A security object compliance management system, comprising:
one or more processors; and
one or more memories, wherein the one or more memories store instructions that, when executed, cause the one or more processors to:
communicatively connect to a plurality of vaults in use by an enterprise, each vault of the plurality of vaults configured to contain security objects associated with the enterprise;
obtain usage data for the security objects of each of the plurality of vaults;
generate a report based on the usage data; and
direct display of the report.

2. The security object compliance management system of claim 1, wherein each of the plurality of vaults is configured to generate a usage log summary of said vault, and wherein the security object compliance manager is configured to obtain the usage data by receiving a respective usage log summary from each of the plurality of vaults.

3. The security object compliance management system of claim 1, wherein each vault of the plurality of vaults is configured to contain a type of security object, wherein the type of security object is one of keys, secrets, or certificates.

4. The security object compliance management system of claim 1, wherein the security objects include security objects for a plurality of different resources.

5. The security object compliance management system of claim 1, wherein the report is responsive to a query received from a user, the query including one or more of a range of time, a user, or a security object.

6. The security object compliance management system of claim 1, wherein the instructions further cause the one or more processors to identify security actions associated with an individual user.

7. The security object compliance management system of claim 6, wherein the instructions further cause the one or more processors to determine an access level recommendation for the individual user based on the security actions associated with the individual user.

8. The security object compliance management system of claim 7, wherein the access level recommendation is a reduction in access level based on a comparison of access privileges of the user with the security actions associated with the individual user.

9. A computer-implemented method for tracking usage of security objects, comprising:
communicatively connecting to a plurality of vaults in use by an enterprise, each vault of the plurality of vaults configured to contain security objects associated with the enterprise;
obtaining usage data for the security objects of each of the plurality of vaults;
generating a report based on the usage data; and
displaying the report.

10. The method of claim 9, wherein each of the plurality of vaults includes an agent configured to generate a usage log summary for said vault, and wherein the security object compliance manager is configured to obtain the usage data by receiving a respective usage log summary from each of the plurality of vaults.

11. The method of claim 9, wherein each vault of the plurality of vaults contains a different type of security object from other vaults of the plurality of vaults, wherein the type of security object is one of keys, secrets, or certificates.

12. The method of claim 9, wherein the security objects include security objects for a plurality of different resources.

13. The method of claim 9, further comprising receiving a query from a user, the query including one or more of a range of time, a user, or a security object, wherein the report is responsive to the query.

14. The method of claim 9, further comprising identifying security actions associated with an individual user.

15. The method of claim 14, wherein the instructions further cause the one or more processors to determine an access level recommendation for the individual user based on the security actions associated with the individual user.

16. The method of claim 15, wherein the access level recommendation is a reduction in access level based on a comparison of access privileges of the user with the security actions associated with the individual user.

17. A system for recommending access privilege levels for one or more users, comprising:
one or more processors; and
one or more memories, wherein the one or more memories store instructions that, when executed, cause the one or more processors to:
communicatively connect to a plurality of vaults in use by an enterprise, each vault of the plurality of vaults configured to contain security objects, each vault of the plurality of vaults configured to contain security objects associated with the enterprise;
obtain usage data for the security objects of each of the plurality of vaults;
receive access privileges for a user;
compare the usage data to the access privileges for each of the plurality of users to determine removable access privileges of the user;
determine proposed access privileges for the user, wherein the proposed access privileges remove one or more of the removable access privileges; and
direct display of the proposed access privileges.

18. The system of claim 17, wherein the instructions further cause the one or more processors to direct display of a log of activity for the user, the log of activity based on the usage data for the security objects.

19. The system of claim 17, wherein the proposed access privileges include a change in group for the user.

20. The system of claim 17, wherein the proposed access privileges include a change in access privileges associated with a role assigned to the user.
